(19) United States
(12) Patent Application Publication
(10) Pub. No.: US 2018/0325640 A1
(43) Pub. Date: Nov. 15, 2018

(54) METHOD AND SYSTEM FOR THE ADMINISTRATION OF ORAL CARE PARTICLES

(71) Applicant: KONINKLIJKE PHILIPS N.V., EINDHOVEN (NL)

(72) Inventors: BART GOTTENBOS, BUDEL (NL); AMIR HUSSEIN RMAILE, EINDHOVEN (NL); MARINUS KAREL JOHANNES DE JAGER, EINDHOVEN (NL); CARL GLASSE, CAMBRIDGE (GB)

(21) Appl. No.: 15/515,638

(22) PCT Filed: Sep. 23, 2015
(86) PCT No.: PCT/EP2015/071810

§ 371 Date: Mar. 30, 2017

(30) Foreign Application Priority Data
Sep. 30, 2014 (EP) 14187155.8

(51) Int. Cl. A61C 19/06; A61C 15/04; A61C 17/02; A61C 17/36

(52) U.S. Cl. CPC A61C 19/063; A61C 15/047; A61C 15/041; A61C 17/36; A61C 17/02

(57) ABSTRACT

Disclosed is a new method, and a system, for the delivery of particles comprising at least one oral care agent to the oral cavity, so as to particularly enable delivery into the interproximal spaces. The method involves providing a liquid comprising the particles and introducing the liquid into the oral cavity in the form of a fluid jet, said jet having a velocity of from 0.5 m/s to 5 m/s. The fluid jet can be generated by an appropriately adapted oral irrigator, but other devices can be used as well. The invention is particularly suitable for the delivery of adhesive gel particles comprising one or more oral care agents, preferably particles for the controlled and/or slow release of such agents.

### FIELD OF THE INVENTION

The invention is in the field of oral care, and pertains to a system and a method for the administration of oral care agents in the form of particles. Notably, the invention pertains to the interproximal delivery of adhesive gel particles.

### BACKGROUND OF THE INVENTION

The human oral cavity, notably teeth and gums, is generally in need of oral care agents. Think of, e.g., antiplaque agents, anti-tartar agents, anti-gingivitis agents, anti-bacterial agents, and others.

Such agents are generally administered from toothpastes and/or oral rinse liquids. Due to the typical environment of the oral cavity, e.g. having saliva present, a standard difficulty in the art is that active agents from toothpastes and oral rinses are quickly reducing in concentration after their application. Therefore they cannot protect the mouth for long times, and they need therefore to be applied several times daily.

WO 2008/135957 discloses a method for cleaning dental plaque biofilm from teeth wherein a liquid gelable composition is applied to the teeth. From the composition a gel layer is produced, wherein the gel layer adheres more strongly to the dental plaque bio film than the bio film adheres to the teeth. Ultimately the gel layer is removed from the teeth, and the dental plaque biofilm along therewith, as the dental plaque biofilm adheres to the gel layer.

The in situ formation of the gel can be realized by first administering a gelable liquid (e.g. based on chitosan), and then administering a second liquid (e.g. a sodium hydroxide solution) to bring about gelation. Other methods are disclosed in WO 2008/135957 as well, all involving the in situ formation of the gel. This has certain drawbacks in that not every user will be capable of correctly conducting the gel formation. It would therefore be desirable to provide a gel composition that is ready to use. This, however, brings about another challenge.

It will be interesting to provide oral care agents in the form of particles. These can be, e.g., solid particles, gel particles, vesicles, but also other three-dimensional structures are envisaged. Such particles would notably serve to provide a controlled release, e.g., a sustained release, of oral care active agents therefrom. This would be an attractive solution to maintain the concentration of oral care agents for longer times or to slow down the decrease in concentration of oral care agents. Particles, notably gel particles, generally have a low volume of solids (typically 1-2%) and therefore can contain a large volume of active formulation.

However, the actual delivery of active agents from particles administered into the oral cavity is very challenging, due to the short period of time that such particles will stay in the mouth, as well as due to the short application time (e.g. 2 min of brushing, 1 min with AirFloss, 30 sec rinsing). This is even more strongly a problem in connection with the interproximal space (the gap between teeth).

The interproximal space is the area in the mouth that is most prone to oral disease, since bacteria can easily accumulate in these spaces to cause disease. Common diseases like gingivitis and caries are most prevalent in the interproximal area. Delivery of slow release anti-plaque agents in the interproximal area may be able to prevent or reduce such diseases.

As this area is secluded, retaining controlled release systems therein is relatively easy, provided that they can be properly delivered in the first place. It would be desirable to achieve such delivery, as on the alternative tooth surfaces (e.g. buccal and lingual), administered particles are prone to be easily removed by, for example, eating. Another advantage is that the user generally does not feel particles located in the interproximal space.

Oral care particles, also for controlled release (such as sustained release) would conventionally be delivered from suspensions simply applied by 30 s rinsing with 20 to 30 ml of a formulation, as is the current practice when using common antimicrobial mouth rinses. However for delivery in the interproximal space this is far from optimal. Particularly, when rinsing, most of the formulation will be spit out, and most of the particles will adhere to other oral surfaces outside the interproximal area. The interproximal areas that are tighter might not even be treated at all. The only available, and only slight, improvement could be by applying excessive amounts of slow release particles. However, the results are still not optimal, if not just marginal. Moreover, applying excessive amounts of slow release particles would be undesirable for economic reasons, since slow release systems are generally more expensive than common mouth rinse ingredients.

WO 2013/093798 describes a device and a method for the delivery of particles, such as encapsulated whitening agent, wherein a pressurized fluid is employed to carry particles comprising a dental care agent, when sprayed from the device. However, a jet device cannot just be used, as therewith the deposition of particles in the interproximal area is limited.

It is desired to provide a way to administer oral care agents in the form of particles in such a way that they are less prone to being spitted out or swallowed, and particularly are provided with a better substantivity, i.e., a longer residence time in the oral cavity, than would be naturally given, preferably by being deposited and retained in the interproximal spaces. It is noted that substantivity, such as retention in the interproximal spaces, plays a particular role in view of the non-invasive character of the administration of oral care agents. This is different from injecting a drug into the body, in order to have it taken up in circulation and act systemically rather than locally.

### SUMMARY OF THE INVENTION

In order to better address the foregoing desires, the invention, in one aspect, concerns a system for the administration, to the interproximal spaces of a subject's teeth, of particles comprising at least one oral care agent, the system comprising a container unit adapted to contain said particles and an oral irrigator comprising a fluid jet generator unit, wherein the container unit is in fluid communication with a source of liquid, and wherein the system is adapted so as to allow the fluid jet generator unit to generate a single fluid jet comprising the particles, at a jet velocity of from 0.5 m/s to 5 m/s.

In another aspect, the invention presents a method for the administration, to the interproximal spaces of a subject's teeth, of particles comprising at least one oral care agent; the method comprising introducing the particles into the oral cavity by means of a single fluid jet, said jet having a velocity of from 0.5 m/s to 5 m/s.

In a further aspect, the invention provides the use of an oral irrigator for the administration of particles comprising at least one oral care agent, the administration comprising allowing the oral irrigator to generate a fluid jet comprising the particles, said jet having a velocity of from 0.5 m/s to 5 m/s.

### BRIEF DESCRIPTION OF THE DRAWINGS

FIGS. 1-7 are macroscope photographs resulting from a test for particle deposition in the interproximal space.

FIG. 8 schematically shows an embodiment of a system for the administration of particles to the interproximal spaces of a subject's teeth.

### DETAILED DESCRIPTION OF EMBODIMENTS

In a general sense, the invention is based on the judicious insight that jet technology, such as is available in the form of oral irrigators, can be used for the transport of a particulate oral care composition to the interproximal space, based on a jet speed (jet velocity) in a range of from 0.5 m/s to 5 m/s.

Jet generating devices such as oral irrigators have been applied in the art for purposes such as interdental cleaning (flossing). For this purpose, these devices, also known as interdental cleaners, have turned out to be greatly effective. Effective cleaning of the dental interproximal space would normally be at odds with delivering substances to said space. Rather, the interdental cleaning serves the purpose of removing substances (notably dental plaque) contained in the interproximal spaces. In accordance with the foregoing, WO 2013/093798 describes spray velocities running from 10 m/s to 300 m/s, e.g. 50 m/s.

It has now been found that jet generating devices can, surprisingly, be used for the quite opposite purpose of delivering substances to be retained in the interproximal space. As explained above, this enables the delivery of non-immediate release, e.g. slow release, oral care agents to the very location in the oral cavity that would be most optimal for achieving retention of these agents. In accordance with the invention, the jet velocity is thereby adapted so as to be in a range of from 0.5 m/s to 5 m/s. Preferably, the jet velocity is below 1 m/s to 3 m/s, more preferably in a range of from 1.5 m/s to 2.5 m/s. A most preferred jet velocity is approximately 2 m/s.

The invention thus relates to a novel use of an oral irrigator, such as an interdental cleaner, for the administration of particles comprising at least one oral care agent. Thereby the particles are comprised in a liquid, or otherwise capable of being transported via a jet. Although the invention can be applicable to the introduction of any liquid into the oral cavity, its benefits will be expressed most in the event of oral care agents of the slow release or sustained release type, or other forms of non-immediate release such as agents of the controlled release type. This includes slow release or sustained release, but it can also refer to triggered release, such as release controlled by an external trigger, e.g. a pH drop or a temperature increase, as well as peaked release.

The oral care agent can itself be in the form of particles, or it can be contained in particles (e.g. in the event particles having a polymeric gel matrix, micro- or nanocapsules, liposomes or other vesicles, and the like. This presentation of an oral care agent in, or as, particles is most preferred in the event of controlled release agents. It will be understood that, in the event of particulate matter to be delivered to the oral cavity, the benefits of retention in the interproximal spaces are optimal, as compared to delivery to other intra-oral surfaces, from which particulate matter will be most strongly prone to removal by saliva, by eating, or by rinsing. It will also be understood that, for controlled release agents, the benefits of retention are expressed most.

The invention now allows particles to be delivered interdentally, and preferably be retained in the interproximal spaces. In order for the particulate oral care agent to be administered as a fluid jet, it will preferably be provided (in advance or, in situ, in the oral irrigator) as a suspension. Generally this will be a suspension in water, but other dentally acceptable liquids, such as ethanol, are not excluded.

Further to the novel use of the invention, also a novel method of administration is provided. Accordingly, the invention presents a method for the administration of particles comprising at least one oral care agent by introducing the particles into the oral cavity by means of a fluid jet, said jet having a velocity as mentioned above.

The introduction of the particles comprising the oral care agent as a fluid jet, can be done by means of any device or unit capable of generating a fluid jet. E.g., in one embodiment, this can be a nozzle which is fed with the liquid under a pressure sufficient to generate the desired jet speed. In the method of the invention, the nozzle is directed to the mouth, such as to introduce the fluid jet into the oral cavity. Preferably, the device is adapted so as to enable directly reaching the interproximal spaces. To this end, the nozzle can take the form of a flexible or rigid tube, having a tip the dimensions of which allow a sufficient degree of precision at directing the fluid jet expelled therefrom to a desired location within the oral cavity, preferably such that localization directly into the interproximal spaces is possible. Alternatively, a syringe can be applied. An oral irrigator typically has a single nozzle, as the device is intended for the separate and precise cleaning of individual location, such as interproximal spaces, in the oral cavity.

In an interesting embodiment, a pulsed jet delivery of approximately 0.1 ml is provided by a plunger pump, for example driven by a pre-loaded spring. As compared to existing devices such as Philips AirFloss, a longer feeding tube to the nozzle is preferred, so as to optimize its reach inside the mouth. After each shot the syringe can be refilled from a larger suspension reservoir (as a container unit), while loading the spring.

The skilled person will be aware of devices and nozzles that are suitable for the aforementioned purposes. Particularly suitable types of devices are the above-mentioned oral irrigators, including interdental cleaners and liquid-assisted flossing devices.

An oral irrigator, such as an interdental cleaner, typically comprises a source of liquid; a system for moving a selected amount of liquid from the source thereof into a liquid pathway; a driving unit such as a pump or a source of pressurized gas, or a combination thereof; and a control arrangement for releasing a selected amount of gas into contact with the liquid, resulting in liquid being propelled out of a nozzle portion of the cleaner. Suitable devices are described, inter alia, in WO 2010/055433, WO 2010/055434, WO 2008/012707, WO 2014/068431.

The oral irrigators to which the invention applies, particularly function on the basis of a single nozzle being used at a time. These device are adapted to be used for applying a liquid jet to each individual interproximal space separately. Also, it is to be understood that an oral irrigator is a device that, upon use, is held in the hand while kept outside of the mouth, or at least not in touch with the teeth. This is opposed to devices such as mouthpieces that are essentially to be placed over teeth, and kept in the mouth during their use. The fundamental distinction between such devices is known in the art, see e.g. the background section in US 2013/236851.

The fluid jet-generating devices suitable for use in the invention can be adapted to provide continuous jets, or separate shots of jets, or both. For the use and method of the present invention it is preferred if single shots can be provided. This would allow a greater precision in administering agents to the various interproximal spaces one at a time. Such preferred devices are well-known in the art.

According to the invention, the device should be able to generate a fluid jet having a velocity in the range of from 0.5 m/s to 5 m/s. This is generally below the jet velocities provided by oral irrigators, interdental cleaners, and the like, which are well above 10 m/s (e.g. up to 300 m/s as discussed in WO 2013/093798 or 10 m/s to 100 m/s, e.g. 50 m/s, as in WO 2010/055435). The jet velocity can be easily adjusted by using an appropriately lower pressure.

In an interesting embodiment, an oral irrigator for use in the present invention is provided with an adjustable jet velocity. This allows a multipurpose use of the device, viz. for interdental cleaning as well as for delivery of agents. In an embodiment hereof, the system is adapted to the delivery of particles, more particularly to the pulsed delivery of particles. To this end a particle delivery setting is added to an oral irrigator device, which provides for a much lower speed, i.e. jet velocities of 0.5 m/s to 5 m/s, than in conventional oral irrigators as discussed above.

For pulsed delivery the setting provides for giving single pulses of a particle suspension, after which it stops, so as to enable the user to choose to again target the same interproximal space or, e.g., to move the system for delivery to the next interproximal space. In an interesting embodiment this can be automated, and particularly combined with oral irrigation. E.g., the system is adjusted to allow the user to push a button when the device is properly positioned, upon which the device will then first generate a high speed shot (e.g., 20 to 30 m/s) for cleaning purposes (or, if desired multiple pulsed shots), and then a low speed shot with particles to deposit (e.g. 0.5 m/s to 5 m/s, preferably 1 m/s to 2 m/s). In one embodiment, the system of the invention has a single nozzle. In another embodiment, the system of the invention includes dual-nozzle devices, wherein both nozzles can be used to target the same interproximal space. Thereby each individual nozzle preferably has a single task, either cleaning or depositing particles, whereby the nozzles are operated sequentially.

As the skilled person will be aware, in a pressurized gas jet device, speed is related to the square root of the pressure applied to generate a jet, so a ten-fold lower speed needed, means a hundred-fold lower pressure. So if, e.g., the cleaning shot (20 m/s) requires a 4 bar pulse, the depositing shot at 2 m/s needs a 40 mbar pulse. In the event of a piston pump (such as a syringe), the speed generated is related to the movement speed of the piston, which is linear with the volume flow rate, so there the piston, in the foregoing example, has to be moved ten times slower for the particle depositing shot than for the regular cleaning shot. This can, of course, be programmable with a driving motor, or, in an alternative embodiment, two driving motors could be provided for the two different types of shots, or two different fluid delivery systems can be built in into a single device.

As mentioned above, an oral irrigator will normally be linked to one or more sources of liquid. This can refer to a single source of liquid, or a single container comprising liquid, or to multiple sources of liquid or containers. E.g., separate sources or containers can be provided for cleaning (e.g., plain water) and for delivery (i.e., a liquid comprising one or more oral care agents, or a source of oral care particles that can be in situ combined with jetted water).

In this respect, the present invention also pertains to a system for the administration of particles comprising at least one oral care agent. The system of the invention comprises a container unit adapted to contain said particles, wherein the container unit is in fluid communication with a source of liquid, and a fluid jet generator unit. The system is adapted so as to allow the fluid jet generator unit to generate a fluid jet comprising the particles, at a jet velocity of from 0.5 m/s to 5 m/s, preferably 1 m/s to 3 m/s, more preferably 1.5 m/s to 2.5 m/s and most preferably 1 m/s to 2 m/s.

The fluid jet generator will be as discussed above in respect of oral irrigators, such as interdental cleaners. The container unit can be part of a fluid jet generating device, but it can also be a separate unit, whereby fluid communication is provided between an outlet of the container and an inlet of the jet generator. Such fluid communication can be provided by suitable tubes or flow lines, with suitable fixation of one to the other. Also, the jet generator unit can be provided with a holder for a cartridge, whereby the cartridge serves as a container for the liquid. The source of liquid, with which the container unit is in fluid communication, can be present in the container itself, viz. as a suspension comprising the particles. The source of liquid can also be provided from one container, and the particles from another. The source of liquid can also be an external source, to which the system of the invention can be hooked-up, or with which the system of the invention can be connected, so as to provide the required fluid communication between the container unit for the particles, and the source of liquid.

The system of the invention preferably further comprises a dental appliance for cleaning teeth, selected from the group consisting of electric toothbrushes, electric flossing devices, and combinations thereof. Such dental appliances can be provided for various functions. This typically refers to a toothbrush, preferably an electrical toothbrush, more preferably a sonic power toothbrush having a vibrating brushhead.

If not already provided by the jetting system of the invention itself, an electric flossing device, as is possibly comprised in the system of the invention, refers to such devices that serve to clean the interdental spaces generally by spraying air, by spraying liquid, or a combination thereof.

A typical oral care composition for use in the system of the invention will comprise a gel particle, bead or capsule as a carrier, and one or more oral care agents. The composition can be directed to a specific use, such as a dedicated antibacterial composition, a dedicated anti-inflammatory agent, or it can comprise a combination of active agents, such as present, e.g., in toothpaste or mouthwash. Particularly, the composition for use in the system of the invention can comprise mouthwash particles, suspended in a regular mouthwash.

It is to be understood that the system can comprise its various parts as separate components, not packaged or provided together.

Particularly, the container holding the particles comprising at least one oral care agent can well be provided as a separate entity, e.g., in the form of a bottle or tube holding the composition (comparable to a bottle of mouthwash or a toothpaste tube). The container can also be attached to the delivery device, particularly as a cartridge adapted for such an attachment, e.g. to an electric toothbrush (designed with a separate fluid delivery system), flossing device or an oral irrigator, such as a Philips Sonicare AirFloss or Philips Sonicare Toothbrush, with a delivery pump.

In an interesting further embodiment, the system according to the invention comprises a power module and one or more dental appliance heads that can be removably attached to said power module. This typically refers to having an electric toothbrush and/or an electric flossing device, both preferably provided as functional modules in the form of dental appliance heads.

The particles comprising at least one oral care agent preferably comprises a polymeric composition that is capable of forming solid particles, gel particles or capsules. Suitable polymers include polymethyl methacrylate beads, or methyl methacrylate copolymer beads. These are known, e.g., from the field of antibiotics, particularly as used in the treatment of hip infections. Preferred polymeric compositions are gels made of polysaccharide, particularly chitosan. Chitosan is known to be mucoadhesive. This is an advantage for the invention, as it adds to the retention of the agent.

Suitable mucoadhesive gels are described, e.g., in Fini et al., Pharmaceutics 2011, 3, 665-679. Other adhesive composition can also be used. Reference is made, e.g., to US 2007/258916, wherein dental compositions are described that are given a high viscosity for better adherence to teeth. Also, a phosphoric acid gel carrier is described that serves to further improve retention on dentin surfaces. It will be appreciated that the skilled person is well aware of various different oral care compositions designed to deliver active agents locally to the teeth, and which will benefit from the possibility of the invention to deliver it to the interproximal spaces.

One or more oral care agents can be present in the particles, but one or more additional oral care agents can also be present separately. Such additional oral care agents can be present in the form of particles, or comprised in particles, and be dispersed in the liquid, but the additional oral care agents can also be dissolved components of the liquid applied in the invention.

The oral care agents applied with the invention are preferably selected from the group consisting of anti-inflammatory agents, antiplaque agents, anti-tartar agents, anti-gingivitis agents, anti-bacterial agents, anti-caries agents, and combinations thereof.

A preferred anti-caries agent is fluoride. Suitable fluoride sources include sodium fluoride, stannous fluoride, sodium monofluorophosphate, zinc ammonium fluoride, tin ammonium fluoride, calcium fluoride, cobalt ammonium fluoride potassium fluoride, lithium fluoride, ammonium fluoride, zinc ammonium fluoride, tin ammonium fluoride, calcium fluoride, cobalt ammonium fluoride, water soluble amine hydrofluorides, or mixtures thereof. The fluoride is preferably present in an amount of at least 0.001%, more preferably, from 0.01 to 12%, and most preferably, from 0.1 to 5% by weight of the total liquid applied into the oral cavity.

Other possible oral healthcare active agents that can be included in either or both of the particles and the liquid are, e.g., antibacterial agents. These include, for example, phenolics and salicylamides, and sources of certain metal ions such as zinc, copper, silver and stannous ions, for example in salt form such as zinc, copper and stannous chloride, and silver nitrate. These are present in art-known small quantities when used. Typical oral care agents in common usage are chlorhexidine digluconate, cetylpyridinium chloride, stannous fluoride, sodium fluoride, hydrogen peroxide, zinc citrate, benzethonium chloride, zinc lactate, phenolic compounds (e.g., thymol, menthol, eucalyptol), triclosan, herbal extracts (e.g. sanguinarine).

The particles can be, e.g., solid particles, gel particles, vesicles, but also other three-dimensional structures are envisaged. It is generally known to the skilled person how to make such particles. Preferred particles are controlled release particles. These are frequently made of polymers. Particularly biodegradable (natural or synthetic) and non-biodegradable polymers are widely used in controlled release applications. The most common polymer types are:

Acryl and vinyl polymers: cross linked acrylic acid-based polymers present swellable behaviour in aqueous solutions due to the presence of ionisable functional groups. Under certain pH they acquire charge and the electrostatic repulsion between these groups favours the intake of water and the expulsion of the agent. This feature makes them suitable candidates for pH-triggered controlled release, at specific sites. Some of these polymers are commercialized under the names Carbopol®.

Lactic and glycolic acid-based polymers show excellent biocompatibility and hydrophilic nature, which makes them good choices for controlled release and drug delivery.

Polysaccharides such as chitosan and its derivatives are water soluble, non-toxic, biocompatible and biodegradable. They, and their combination with poly (acrylic acid) or poly (methyl methacrylate), are mostly used to produce cross linked micro and nanoparticles for controlled release of proteins, vaccines, pharmaceutical compounds and pesticides.

Cellulose-derived polymers, which present different hydrophilicity, swelling and degradation behaviour, also offer a flexible and tuneable alternative for controlled release. Commercial examples of these materials are ETHOCEL™, METHOCEL™ and POLYOX™.

Poly (β-amino ester) polymers are also used to design pH-responsive polymer microspheres. Such systems degrade slowly at pH 7.4 but enable a fast and quantitative release (up to 90% of the encapsulated agent) in acidic conditions, which is of interest in biomedical applications to achieve specific different release rates within the physiological pH of the specific site.

Mixed inorganic-organic polymers: silicones.

While the invention has been illustrated and described in detail in the drawings and foregoing description, such illustration and description are to be considered illustrative or exemplary and not restrictive; the invention is not limited to the disclosed embodiments.

For example, it is possible to operate the invention in an embodiment wherein a plurality of different agents is administered via a single suspension.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain features of the invention are recited in mutually different dependent claims does not indicate that a combination of these features cannot be used to advantage. Any reference signs in the claims should not be construed as limiting the scope.

In sum, we hereby disclose a new method, and system, for the delivery of particles comprising an oral care agent to the oral cavity, so as to particularly enable delivery into the interproximal spaces. The method involves providing a liquid comprising the particles and introducing the liquid into the oral cavity in the form of a fluid jet, said jet having a velocity of from 0.5 m/s to 5 m/s. The fluid jet can be generated by an appropriately adapted oral irrigator, but other devices can be used as well. The invention is particularly suitable for the delivery of adhesive gel particles comprising one or more oral care agents, preferably particles for the controlled and/or slow release of such agents.

The invention will be further explained hereinafter with reference to the examples and figures. These illustrate the invention, but do not limit it.

### Example 1

As an oral care agent, positively charged chitosan gel particles were used, which bind strongly to all oral surfaces by electrostatic interactions, since both pellicle coated teeth and mucus have a negative surface charge. Chitosan gel particles were manufactured by adding 2 m % highly viscous chitosan powder to 50 mM HCl in demineralised water. Additionally, as a colouring agent 5 m % titanium dioxide was added to make the particles white. The chitosan was left to dissolve for at least 24 h. Subsequently, the 2% chitosan solution was dripped in a 50 mM NaOH solution in demineralised water, up to 40 v % chitosan solution (i.e. 40 v % of 2% chitosan solution and 60 v % 50 mM NaOH solution). The drops were left to gel for at least 30 min. Then the chitosan gel balls were blended to small particles using an UltraTurrax blender at 25,000 rpm for 1 min. The obtained gel particles ranged from 20 to 200 micrometer, and the suspension had a pH of 12. The 40 v % chitosan particle suspension was diluted 10 times in a 4 mM phosphate buffer of pH 6.5, rendering a 4 v % particle suspension of pH 7.5.

### Example 2

Interproximal delivery of particles was tested in an anatomical model of the interproximal space made of black Nylon.

A 0.25 ml glass syringe (Gastight #1725, Hamilton, USA) with an orifice of 1.12 mm diameter was positioned with the exit nozzle against the model interproximal space, having two clean but wet proximal surfaces. The syringe was aligned parallel to the proximal surfaces (0 degree impact angle). The syringe was filled with 0.15 ml particle suspension, and the syringe plunger was pushed with a linear actuator to create a jet with a total dispensed volume of 0.1 ml. The linear actuator was pneumatically driven, and the speed was determined by the input gas pressure. Table 1 shows the different jet speed settings tested. Manually also very slow speeds were tested (ca 5 cm/s). The jet timing was measured using a high-speed camera. After the delivery shot the samples were taken out of the model, and rinsed by dipping in a large beaker of demineralised water. After imaging the samples were rinsed with a high velocity jet (5 to 10 m/s) from a wash bottle, and imaged again to look at retention.

TABLE 1
Different jet velocities tested. Calculated from jet time, volume and
nozzle diameter.

| Total jet time (ms) | Average jet velocity (m/s) |
|---|---|
| 166 | 0.59 |
| 61 | 1.63 |
| 52 | 1.91 |

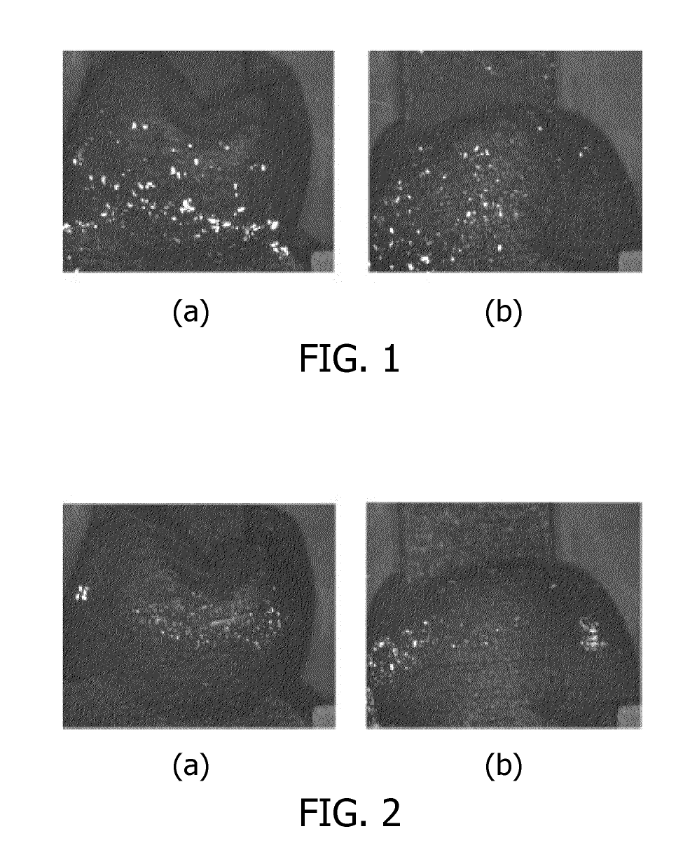

Very slow manual speeds (5 cm/s) were not delivering any particles inside the interproximal space. Instead the fluid ran down at the outside of the teeth. FIGS. 1a and 1b to 3a and 3b show example images, of the proximal surfaces after particle delivery at different actuator driven speeds. The lowest velocity delivers a smaller number of large particles, mainly at the bottom of the interproximal space. The highest velocity deposits a large number of small particles over the full tooth surface. After rinsing with a wash bottle some particles are lost from the one delivered with the lowest speed, while most on the high-speed delivered surfaces remain.

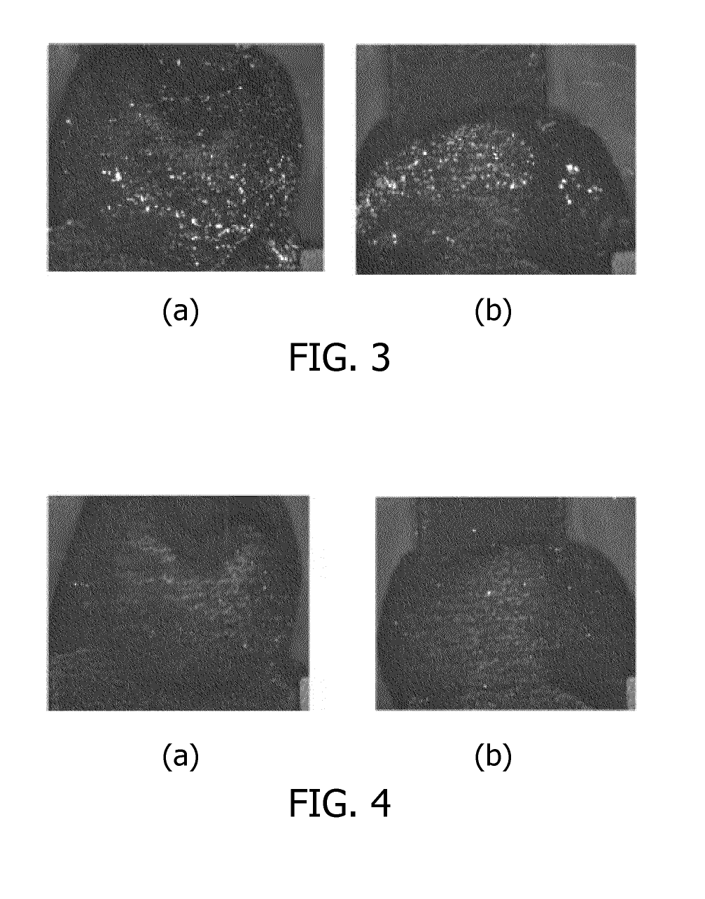

FIG. 1 relates to 0.59 m/s, FIG. 2 to 1.63 m/s, and FIG. 3 to 1.91 m/s. For each figure, (a) indicates the left surface, and (b) indicates the right surface.

Higher jet speeds of around 2 m/s are most optimal for the interproximal delivery of smaller particles (20-50 micrometer diameter). A well usable velocity range is 1 to 5 m/s. To deposit larger particles (50 to 200 micrometer) the more optimal range is 0.5 to 1 m/s.

### Example 3 (Comparative)

A conventional oral irrigator, viz. Philips AirFloss was used to deliver a 4 v % chitosan gel particle suspension similar to Example 2. A current production model of AirFloss (volume 0.15 ml/shot) was used, and the delivery was done from both sides (buccal side). Jet velocity was above 15 m/s.

The result is shown in FIG. 4, again with (a) showing the left surface, and (b) indicating the right surface of an anatomical model of the interproximal space made of black Nylon. As shown, by lack of white spots, very few particles were deposited inside the interproximal area.

### Example 4 (Comparative)

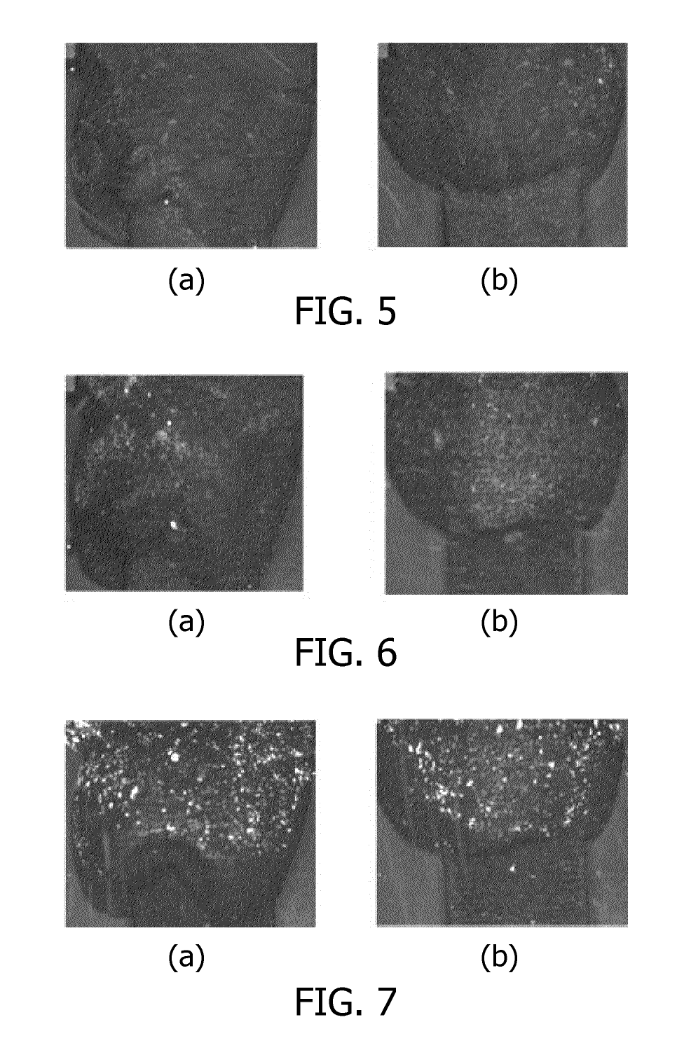

Another conventional oral irrigator, viz. Waterpik® 100 was used to deliver a 200 micro-L/shot 4% Chitosan particles (4% chitosan-Ti0₂ beads (2% HV Chitosan+5% TiO₂ in 4 mM PO4 buffer, pH 7.4). Various device settings for jet velocity, from 6 m/s to over 15 m/s were applied, and compared with delivery at a manual jet velocity of 1.5 m/s. FIGS. 5 to 7 show the respective photographs of the results of particle delivery. In each figure, the photographs (a) show the left surface, and the photographs (b) show the right surface of an anatomical model of the interproximal space made of black Nylon. FIG. 5 refers to a jet velocity of 15.1 m/s, FIG. 6 to a jet velocity of 6 m/s (the lowest setting for Waterpik® 100), and FIG. 7 relates to delivery according to the invention, at 1.5 m/s. It can be seen that at both of the Waterpik® settings shown, hardly or no particle delivery to the interproximal space is visible. The same holds for several intermediate settings (not shown). Delivery at 1.5 m/s jet velocity, according to the invention, results in extensive delivery of particles (visible in the photographs as white spots).

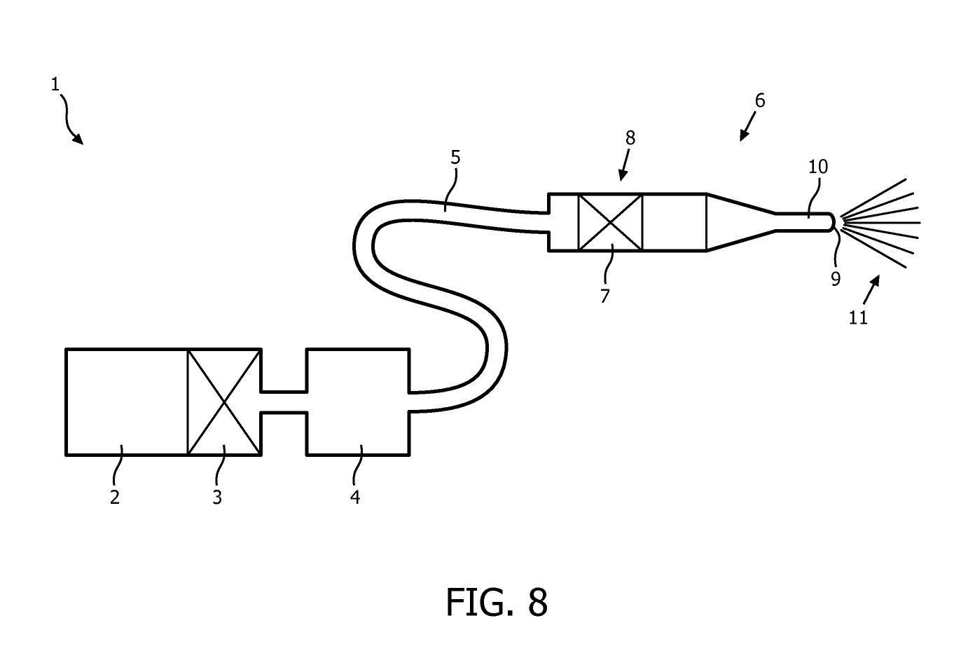

FIG. 8 schematically shows an embodiment of a system 1 for the administration of particles comprising an oral care agent to the interproximal spaces of a subject's teeth. The system 1 comprises a container unit 2 adapted to contain the particles, which container is in fluid communication with a second container 4 comprising a source of liquid. The system further comprises an oral irrigator 6, which is connected to the second container 4 via a flexible tube 5. The container unit preferably comprise a delivery system 3 to deliver the particles comprising at least an oral care agent to the second container. Delivery of the particles to the liquid can be done in a number of ways known to a man skilled in the art. For example one can make use of a constriction in the piping system and suck in the particles via the so-called Venturi effect. Alternatively one uses a piston and cylinder and valve provided at a cylinder outlet. In some embodiments the container unit and second container are integrated in one container, wherein the particles are dispersed in a liquid. Such integrated container also comprises a delivery mechanism to deliver the particles and fluid to the oral irrigator. In other embodiments the container unit and second container are integrated in the oral irrigator 6. The oral irrigator 6 comprises a fluid jet generator unit 8, which preferably comprises a pump 7 such as a plunger pump. The jet generator unit 8 is arranged to generate single shots of a fluid jet 11 comprising the particles, based on the delivery of the liquid and particles from container unit 2 and second container 4. The oral irrigator 6 further comprises a nozzle 10, preferably provided with a cone-shaped tip 9 to have a relatively narrow outflow opening. In a preferred embodiment the nozzle has a curved portion. The flexible tube 5 preferably is sufficiently long to easily reach the inside of subject' oral cavity with the oral irrigator 6 or at least the nozzle 10 thereof.

1. A system for the administration, to the interproximal spaces of a subject's teeth, of mucoadhesive particles comprising at least one oral care agent, the system comprising a container unit containing said particles and an oral irrigator comprising a fluid jet generator unit, wherein the container unit is in fluid communication with a source of liquid, and wherein the system is adapted so as to allow the fluid jet generator unit to generate single shots of a fluid jet comprising the particles, at a jet velocity of from 0.5 m/s to 5 m/s, to the interproximal spaces one at a time.

2. A system according to claim 1, wherein the container unit contains the particles dispersed in the liquid.

3. A system according to claim 1, wherein a second container is present comprising a source of liquid.

4. A system according to claim 1, wherein the fluid jet generator is in fluid communication with an external source of liquid.

5. A system according to claim 1, wherein, the system has a single nozzle configured to administer the particles, and wherein the jet velocity is in a range of from 1 m/s to 5 m/s, preferably 1 m/s to 3 m/s.

6. A system according to claim 1, wherein the particles comprise a gel, preferably comprising gelled chitosan.

7. A system according to claim 1, wherein the oral care agent is selected from the group consisting of dentifrices, antiplaque compositions, anti-tartar compositions, anti-gingivitis compositions, anti-caries compositions, anti-bacterial compositions, compositions for periodontal treatment, and combinations thereof.

8. A system according to claim 1, further comprising a dental appliance for cleaning teeth selected from the group consisting of electric toothbrushes, electric flossing devices, oral irrigators, and combinations thereof.

9. A method for the administration of mucoadhesive particles comprising at least one oral care agent into the oral cavity; the method comprising introducing the particles into the oral cavity by means of an oral irrigator generating a single fluid jet at the time, said jet having a velocity of from 0.5 m/s to 5 m/s.

10. A method according to claim 9, wherein the jet velocity is 1 m/s to 3 m/s, preferably 1 m/s to 2 m/s.

11. A method according to claim 9, wherein the fluid jet is provided by an oral irrigator adapted to generate the defined jet velocity.

12. A method according to claim 1, wherein the particles comprise gelled chitosan.

13. The use of an oral irrigator for the administration of mucoadhesive particles comprising an oral care agent into the oral cavity, the administration comprising allowing the oral irrigator to generate a single fluid jet at the time, said jet comprising the particles and having a velocity of from 0.5 m/s to 5 m/s.

14. A use according to claim 13, wherein the jet velocity is 1 m/s to 3 m/s, preferably 1 m/s to 2 m/s.

15. A use according to claim 13, wherein the particles are mucoadhesive, preferably comprising gelled chitosan.
